(19) United States
(12) Patent Application Publication
(10) Pub. No.: US 2025/0029590 A1
(43) Pub. Date: Jan. 23, 2025

(54) AUTOMATED THRESHOLD ADJUSTMENT OF NON-LINEAR PROCESSOR FOR ACOUSTIC ECHO CANCELLATION

(71) Applicant: Shure Acquisition Holdings, Inc., Niles, IL (US)

(72) Inventors: Airas Akhtar, Niles, IL (US); Justin Joseph Sconza, Chicago, IL (US)

(21) Appl. No.: 18/774,427

(22) Filed: Jul. 16, 2024

Related U.S. Application Data
(60) Provisional application No. 63/514,022, filed on Jul. 17, 2023.

(51) Int. Cl. G10K 11/175

(52) U.S. Cl. CPC G10K 11/1752

(57) ABSTRACT

Acoustic echo cancellation systems and methods are provided that can automatically adjust a threshold of a non-linear processor based on the state of a conferencing session, such as a far end single talk condition or a doubletalk condition. The state of the conferencing session may be detected based on various combinations of metrics that are measured from a microphone signal and a remote audio signal. The systems and methods can improve the removal of residual echo and therefore enhance the overall performance of the acoustic echo cancellation system.

### CROSS-REFERENCE

This application claims the benefit of U.S. Provisional Patent Application No. 63/514,022, filed on Jul. 17, 2023, which is fully incorporated by reference in its entirety herein.

### TECHNICAL FIELD

This application generally relates to a non-linear processor used in an acoustic echo cancellation system, and more particularly, to the automated threshold adjustment of the non-linear processor.

### BACKGROUND

Conferencing environments, such as boardrooms, conferencing settings, and the like, can involve the use of microphones (including microphone arrays) for capturing sound from audio sources and loudspeakers for presenting audio from a remote location (also known as a far end). For example, persons in a conference room may be conducting a conference call with persons at a remote location. Typically, speech and sound from the conference room may be captured by microphones and transmitted to the remote location, while speech and sound from the remote location may be received and played on loudspeakers in the conference room. Multiple microphones may be used in order to optimally capture the speech and sound in the conference room.

However, the microphones may pick up the speech and sound from the remote location that is played on the loudspeakers in the conference room. In this situation, the audio transmitted to the remote location may include an echo, e.g., the speech and sound from the conference room as well as the speech and sound from the remote location. If there is no correction, the audio transmitted to the remote location may be low quality or unacceptable because of this echo. In particular, it would not be desirable for persons at the remote location to hear their own speech and sound. Typical acoustic echo cancellation systems utilize an adaptive filter, e.g., a finite impulse response filter, on the remote audio signal to generate a filtered signal that can be subtracted from the local microphone signal to remove linear echo. Residual echo that cannot be removed by the adaptive filter can be removed by a non-linear processor.

### SUMMARY

The techniques of this disclosure are directed to providing systems and methods that are designed to, among other things: (1) calculate the maximum value of a ratio between a level of the microphone signal and a level of the filtered remote audio signal, based on collecting, over a period of time, a plurality of samples of the ratios; (2) set a threshold of a non-linear processor in an acoustic echo cancellation system to an amount above a maximum value of a ratio between a level of a microphone signal and a level of a filtered remote audio signal, when a conferencing session is in a far end single talk condition; and (3) set the threshold of the non-linear processor to a particular value, when the conferencing session is in a doubletalk condition.

In an embodiment, a device includes one or more processors, where any of the one or more processors is configured to determine whether a conferencing session is in a far end single talk condition, based on a microphone signal and a filtered remote audio signal; and based on the conferencing session being determined to be in the far end single talk condition, set a threshold of a non-linear processor to be a predetermined amount above a ratio between a level of the microphone signal and a level of the filtered remote audio signal.

In another embodiment, a method includes determining whether a conferencing session is in a far end single talk condition, based on a microphone signal and a filtered remote audio signal; and based on the conferencing session being determined to be in the far end single talk condition, setting a threshold of a non-linear processor to be a predetermined amount above a ratio between a level of the microphone signal and a level of the filtered remote audio signal.

These and other embodiments, and various permutations and aspects, will become apparent and be more fully understood from the following detailed description and accompanying drawings, which set forth illustrative embodiments that are indicative of the various ways in which the principles of the invention may be employed.

### BRIEF DESCRIPTION OF THE DRAWINGS

FIG. 1 is a schematic diagram of a communication system including an acoustic echo cancellation system that includes a metric estimator and a non-linear processor, in accordance with some embodiments.

FIG. 2 is a schematic diagram of the non-linear processor of the acoustic echo cancellation system in the communication system of FIG. 1, in accordance with some embodiments.

FIGS. 3A-3B are flowcharts illustrating operations for adjusting a threshold of a non-linear processor based on the detection of a far end single talk condition and/or a doubletalk condition, using the communication system of FIG. 1, in accordance with some embodiments.

### DETAILED DESCRIPTION

The systems and methods described herein can automatically adjust a threshold of a non-linear processor in an acoustic echo cancellation system. A non-linear processor can be utilized to remove residual echo that cannot be removed by an adaptive filter, and to ultimately generate an echo-cancelled audio signal that can be transmitted back to the far end. In particular, a mask value may be generated for use as a gain of the non-linear processor to suppress the residual echo in particular frequency bands. For example, when the gain of a non-linear processor is 0, residual echo may be fully suppressed, and when the gain of the non-linear processor is 1, no residual echo suppression may occur.

The threshold level of the non-linear processor may relate to the maximum amount of suppression of the residual echo. Adjusting the threshold of the non-linear processor allows the level of the non-linear processor to be changed based on room characteristics and different states that may occur during a conferencing session, such as a far end single talk condition or a doubletalk condition. A far end single talk condition describes a scenario when only the far end remote participant of a conferencing session is speaking and the far end audio is captured by the microphone, and a doubletalk condition describes a scenario when there is simultaneous near end activity and far end activity in the conferencing session.

When using the systems and methods described herein, the overall acoustic echo cancellation system may have improved performance such that there is greater echo suppression during a far end single talk condition and lesser echo suppression during a doubletalk condition. For example, when there is a far end single talk condition in a conferencing session, the threshold of the non-linear processor may be set to be a relatively high value that is a particular amount above, e.g., 2 dB above, the maximum value of a ratio between the microphone input signal (that captures sound in the near end) and the adaptive filter output (which is based on the remote audio signal from the far end). When there is a doubletalk condition in the conferencing session, the threshold of the non-linear processor may be set to a particular relatively low value, e.g., 1 dB, to reduce the amount of echo suppression performed by the non-linear processor.

Automating the threshold adjustment of a non-linear processor in an acoustic echo cancellation system can eliminate the need for a user to manually change parameters of the non-linear processor for different situations and environments. In addition, far end single talk echo leakage performance may be improved when automating the threshold adjustment of the non-linear processor, particularly when the adaptation state of the adaptive filter is not converged, e.g., when the adaptation state is diverged, the adaptation state has not fully converged yet, or when an echo path in the environment changes. Far end single talk leakage can occur in situations when a microphone is physically close to a loudspeaker, for example, such as when the far end audio may be captured by the microphone with a greater energy level that a typical non-linear processor cannot consistently suppress (particularly in low frequency sub-bands). Accordingly, the systems and methods described herein can improve the removal of residual echo by a non-linear processor, resulting in enhanced performance of the overall acoustic echo cancellation system.

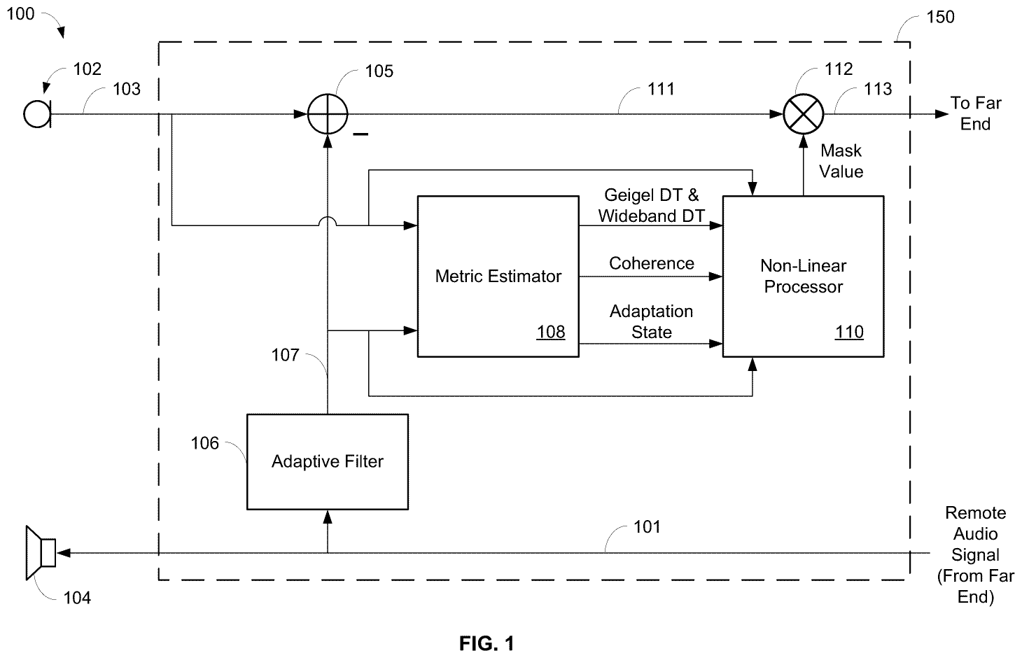

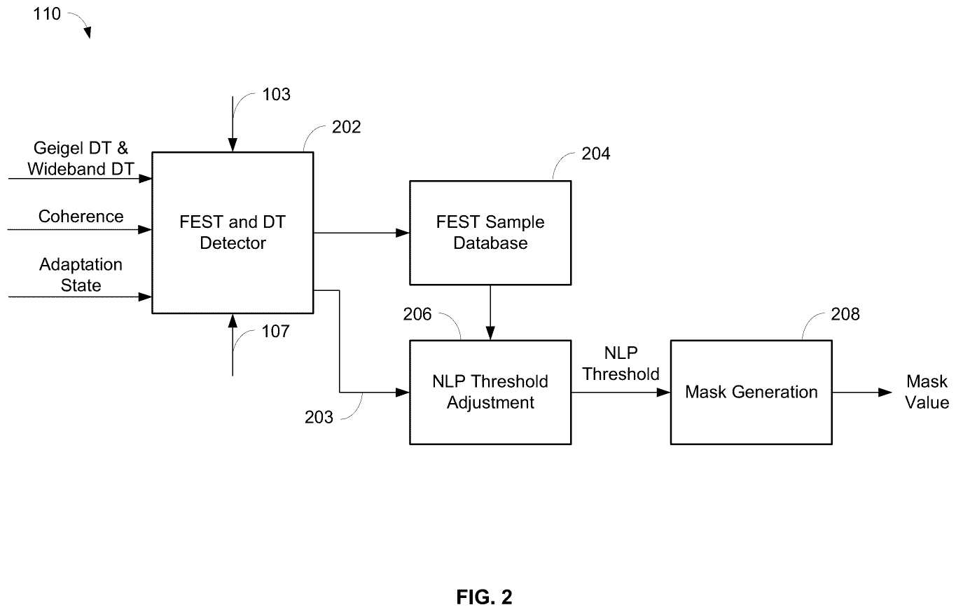

FIG. 1 is a schematic diagram of a communication system 100 for capturing sound from audio sources in an environment using a microphone 102 and presenting audio from a remote location using a loudspeaker 104. The communication system 100 may include an acoustic echo cancellation system 150 that includes an adaptive filter 106, a metric estimator 108, and a non-linear processor 110. Particular components of the non-linear processor 110 are described with respect to the schematic diagram of FIG. 2. The non-linear processor 110 may include a far end single talk (FEST) and doubletalk (DT) condition detector 202, a FEST sample database 204, a non-linear processor threshold adjustment unit 206, and a mask generation unit 208. As described in more detail below, the threshold of the non-linear processor 110 may be automatically adjusted when certain conditions occur during a conferencing session, such as a far end single talk condition or a doubletalk condition.

The communication system 100 may generate an echo-cancelled audio signal 113 using the acoustic echo cancellation system 150. The echo-cancelled audio signal 113 may mitigate the sound received from the remote location that is played on the loudspeaker 104 and sensed by the microphone 102, and in particular, mitigate linear echo and residual echo that is sensed by the microphone 102. In this way, the echo-cancelled audio signal 113 may be transmitted to the remote location without the undesirable echo of persons at the remote location hearing their own speech and sound.

Environments such as conference rooms may utilize the communication system 100 to facilitate communication with persons at the remote location, such as during a conferencing session, for example. The type of microphone 102 and its placement in a particular environment may depend on the locations of audio sources, physical space requirements, aesthetics, room layout, and/or other considerations. For example, in some environments, the microphone 102 may be placed on a table or lectern near the audio source. In other environments, the microphone 102 may be mounted overhead to capture the sound from the entire room, for example. The communication system 100 may work in conjunction with any type and any number of microphones 102.

Various components included in the communication system 100 may be implemented using software executable by one or more servers or computers, such as a computing device with a processor and memory, and/or by hardware (e.g., discrete logic circuits, application specific integrated circuits (ASIC), programmable gate arrays (PGA), field programmable gate arrays (FPGA), etc. In general, a computer program product in accordance with the embodiments includes a computer usable storage medium (e.g., standard random access memory (RAM), an optical disc, a universal serial bus (USB) drive, or the like) having computer-readable program code embodied therein, wherein the computer-readable program code is adapted to be executed by a processor (e.g., working in connection with an operating system) to implement the methods described herein. In this regard, the program code may be implemented in any desired language, and may be implemented as machine code, assembly code, byte code, interpretable source code or the like (e.g., via C, C++, Java, ActionScript, Python, Objective-C, JavaScript, CSS, XML, and/or others).

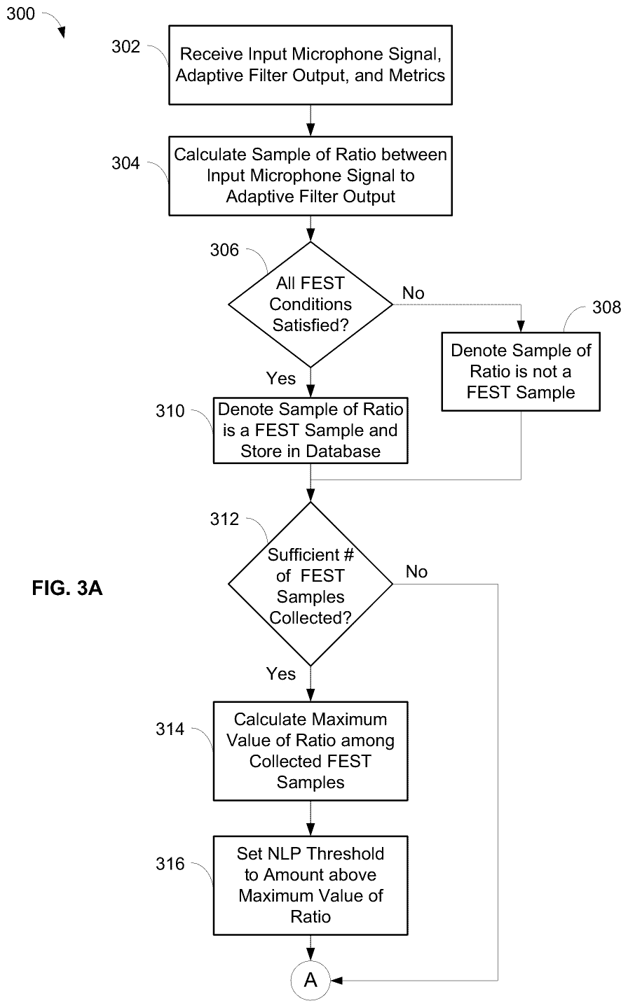

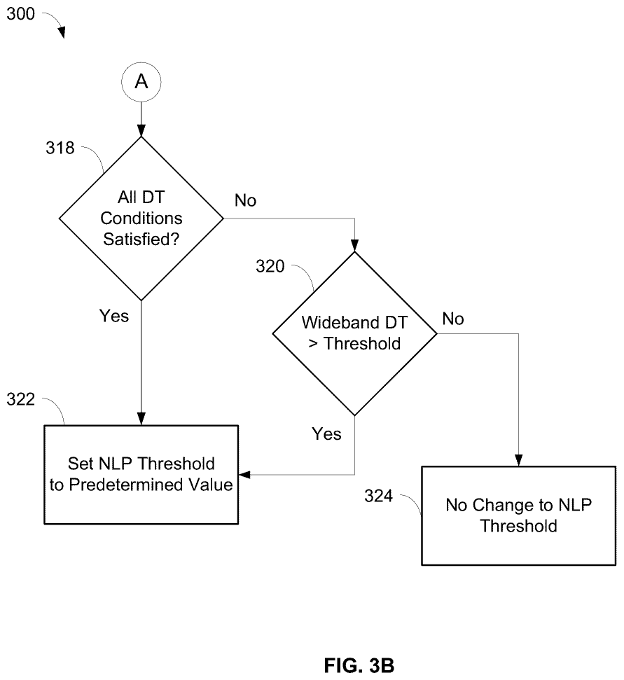

FIGS. 3A and 3B illustrate a process 300 that utilizes the communication system 100 and the acoustic echo cancellation system 150, as shown in FIGS. 1 and 2. In particular, the process 300 shown in FIGS. 3A and 3B may adjust the threshold of the non-linear processor 110 when the state of the communication system 100 is in a particular condition, such as a far end single talk condition or a doubletalk condition. One or more processors and/or other processing components (e.g., analog to digital converters, encryption chips, etc.) within or external to the system 100 may perform any, some, or all of the steps of the process 300. One or more other types of components (e.g., memory, input and/or output devices, transmitters, receivers, buffers, drivers, discrete components, etc.) may also be utilized in conjunction with the processors and/or other processing components to perform any, some, or all of the steps of the process 300.

Referring to FIG. 1, the microphone 102 may detect sound in the environment and convert the sound to an audio signal 103. In embodiments, the audio signal 103 from the microphone 102 may be processed by a beamformer (not shown) to generate one or more beamformed audio signals. Accordingly, while the systems and methods are described herein as using an audio signal 103 from microphone 102, it is contemplated that the systems and methods may also utilize any type of acoustic source, such as beamformed audio signals generated by a beamformer. In addition or alternatively, the audio signal 103 from the microphone 102 and the remote audio signal 101 may be converted into the frequency domain, in which case, the acoustic echo cancellation system 150 can operate in the frequency domain.

The adaptive filter 106 may process the remote audio signal 101 to generate a filtered remote audio signal 107 that represents an estimate of the echo, e.g., an estimate of the remote audio signal 101 as it propagates through its acoustic path, that will be detected by the microphone 102. In embodiments, the adaptive filter 106 may be a finite impulse response filter. The filtered remote audio signal 107 generated by the adaptive filter 106 may be subtracted from the audio signal 103 of the microphone 102 at the summing point 105 to generate an initial echo-cancelled audio signal 111. Linear echo in the microphone audio signal 103 may be suppressed in the initial echo-cancelled audio signal 111. The initial echo-cancelled audio signal 111 may be multiplied by a mask value from the non-linear processor 110 at combining point 112 to suppress any residual echo that has not been fully eliminated at the summing point 105, and to generate the final echo-cancelled audio signal 113.

The metric estimator 108 may process the microphone audio signal 103 and the filtered remote audio signal 107 to determine various metrics that may be utilized by the non-linear processor 110. In some embodiments, there may be multiple microphones 102 with associated metric estimators 108. In other embodiments, there may be an metric estimator 108 for each of several frequency bands.

The metric estimator 108 may determine the adaptation state of the adaptive filter 106. The adaptation state of the adaptive filter 106 can include diverged, converging, or converged. A diverged adaptation state of the adaptive filter 106 may indicate that the adaptive filter 106 has not yet been identified, e.g., the echo path has not yet been identified, and is therefore not actively cancelling the echo. A converging adaptation state of the adaptive filter 106 may indicate that the adaptive filter 106 has started to identify the residual echo and is suppressing at least part of the residual echo. A converged adaptation state of the adaptive filter 106 may indicate that the adaptive filter 106 has identified the residual echo and is suppressing the residual echo.

The metric estimator 108 may also measure the coherence between the filtered remote audio signal 107 and the microphone audio signal 103. The coherence is a measure of the relationship between the frequency content of the filtered remote audio signal 107 and the microphone audio signal 103 from the microphone 102.

Metrics related to doubletalk may be measured by the metric estimator 108, including whether there is Geigel doubletalk and the level of wideband doubletalk that is present in the microphone audio signal 103. Geigel doubletalk refers to the conventional detection of doubletalk using the Geigel algorithm that detects doubletalk based on the magnitude of the difference in gain between the filtered remote audio signal 107 and the microphone audio signal 103. In certain situations, however, Geigel doubletalk detection by itself may not consistently detect a doubletalk condition, such as when echo path changes present themselves as sudden changes in the gain of the microphone audio signal 103. The level of wideband doubletalk in the microphone audio signal 103 can also be detected by the metric estimator 108. The level of wideband doubletalk may refer to the percentage of frequency subbands that indicate Geigel doubletalk.

As shown in the process 300 in FIG. 3A, at step 302, the FEST and DT condition detector 202 in the non-linear processor 110 may receive the microphone audio signal 103, the filtered remote audio signal 107, and the metrics from the metric estimator 108 (e.g., adaptation state, coherence, Geigel doubletalk, and wideband doubletalk). The ratio between the level of the microphone audio signal 103 and the level of the filtered remote audio signal 107 may be calculated by the detector 202 at step 304. As described in more detail below, when it is determined that there is a far end single talk condition in a conferencing session, the threshold of the non-linear processor 110 may be adjusted to be relatively high to be a certain amount above the maximum value of the ratio calculated at step 304.

At step 306, the detector 202 may determine whether the conditions are satisfied for determining whether a conferencing session is in a far end single talk condition. These conditions may be tested for based on the microphone audio signal 103, the filtered remote audio signal 107, and the metrics from the metric estimator 108. For example, the conditions that may be satisfied to determine that a far end single talk condition exists at step 306 may include that: (1) the filtered remote audio signal 107 is above a noise floor, e.g., the amount of background noise in the environment; (2) there is no Geigel doubletalk; (3) the adaptation state of the adaptive filter 106 is converging or converged, e.g., is not diverging; (4) the level of wideband doubletalk is less than a particular threshold, e.g., 20%; and (5) the coherence between the microphone audio signal 103 and the filtered remote audio signal 107 is greater than a particular threshold, e.g., 50%. It is contemplated and possible that other suitable combinations of conditions may be satisfied for determining whether a conferencing session is in a far end single talk condition at step 306.

When this combination of metrics is satisfied at step 306 (“YES” branch of step 306), then at step 310, the ratio calculated at step 304 may be denoted as a FEST sample and can be stored by the detector 202 in a FEST sample database 204. However, when this combination of metrics is not satisfied at step 306 (“NO” branch of step 306), then at step 308, the ratio calculated at step 304 may be denoted as not being a FEST sample and may not be saved.

Continuing to step 312 following step 308 or step 310, it may be determined by the detector 202 whether a sufficient number of samples of the ratios have been stored in the FEST sample database 204, e.g., by step 310 over a certain period of time. Having a sufficient number of samples of the ratios that are associated with FEST samples can help in determining the true level of far end single talk that is occurring during a conferencing session. Moreover, having a sufficient number of samples of the ratios can ensure that abrupt changes do not occur in response to a single sample, for example, so that rapid variations and changes do not unexpectedly occur. In an embodiment, the sufficient number of FEST samples may be 1700 samples at 750 Hz. Other suitable sufficient numbers of FEST samples are contemplated and possible, and could be utilized at step 312. When it is determined that there is not a sufficient number of FEST samples at step 312 (“NO” branch of step 312), then the process 300 may continue to step 318 (as denoted through the connector A shown on FIGS. 3A and 3B).

However, when it is determined that there is a sufficient number of FEST samples at step 312 (“YES” branch of step 312), then a signal 203 may be sent from the detector 202 to the NLP threshold adjustment unit 206 denoting that the threshold of the non-linear processor 110 is to be adjusted, and the process 300 may continue to step 314. At step 314, the NLP threshold adjustment unit 206 may calculate the maximum value of the ratios associated with the FEST samples that have been stored in the FEST sample database 204. As an example, the ratios associated with the FEST samples may range from 0 dB to 20 dB.

Following step 314, the NLP threshold adjustment unit 206 may set the threshold of the non-linear processor 110 at step 316 to be a relatively high value that is a particular amount above the maximum value of the ratio calculated at step 314. In embodiments, the amount may be a predetermined amount, e.g., 2 dB, above the maximum value of the ratio calculated at step 314, but the amount may be another suitable amount. In embodiments, the amount may be dynamically determined based on the maximum value of the ratio calculated at step 314 and/or based on other criteria. Setting the threshold of the non-linear processor 110 to be above the maximum value of the ratio can ensure that there is greater echo suppression performed by the non-linear processor 110 when a far end single talk condition exists in a conferencing session.

The process 300 may continue to step 318 following step 316 (as denoted through the connector A shown on FIGS. 3A and 3B). At step 318, the detector 202 may determine whether the conditions are satisfied for determining whether a conferencing session is in a doubletalk condition. These conditions may be tested for based on the microphone audio signal 103, the filtered remote audio signal 107, and the metrics from the metric estimator 108. For example, the conditions that may be satisfied to determine that a doubletalk condition exists at step 318 may include that: (1) Geigel doubletalk has been detected in a subband; (2) the coherence between the microphone audio signal 103 and the filtered remote audio signal 107 is less than a particular threshold, e.g., 40%; and (3) the level of wideband doubletalk is greater than a particular threshold, e.g., 20%. It is contemplated and possible that other suitable combinations of conditions may be satisfied for determining whether a conferencing session is in a doubletalk condition at step 318.

When this combination of metrics is satisfied at step 318 (“YES” branch of step 318), then at step 322, then a signal 203 may be sent from the detector 202 to the NLP threshold adjustment unit 206 denoting that the threshold of the non-linear processor 110 is to be set to a particular value that is relatively low. In embodiments, the value set at step 322 may be 1 dB, for example, but may be another suitable value. Setting the threshold of the non-linear processor 110 to be a relatively low value can ensure that there is less echo suppression performed by the non-linear processor 110 when a doubletalk condition exists, and therefore that more of the initial echo-cancelled audio signal 111 will be heard.

However, when the combination of metrics for a doubletalk condition is not satisfied at step 318 (“NO” branch of step 318), then the process 300 may continue to step 320. At step 320, it may be determined whether the level of wideband doubletalk is greater than a particular threshold, e.g., 20%, that is not relatively low. If the level of wideband doubletalk is greater than the particular threshold at step 320 (“YES” branch of step 320), then the process 300 may continue to step 322 to set the threshold of the non-linear processor 110 to a particular relatively low value, as described above. The comparison performed at step 320 may be used to detect a doubletalk condition in order to improve the intelligibility of the doubletalk in a conferencing session, at the cost of potential far end single talk leakage. In particular, the comparison performed at step 320 may reflect that a doubletalk condition exists, even if the other conditions that are tested for at step 318 are not yet satisfied. For example, it may take a certain amount of time for the metrics used in step 318 to reflect the real-time situation, since particular metrics are averaged-out signals, so step 320 can help in more quickly determining whether a doubletalk condition exists.

If the level of wideband doubletalk is not greater than the particular threshold at step 320 (“NO” branch of step 320), then there may be no change to the threshold of the non-linear processor 110, as denoted by step 324. As such, if the threshold of the non-linear processor 110 had been set at step 316 (when a far end single talk condition exists), then the threshold would stay at that relatively higher value. However, when a doubletalk condition exists (e.g., as determined at step 318 or step 320), then the threshold of the non-linear processor 110 would be set at step 322 to a lower value than may have been previously set at step 316.

In embodiments, the operation of the non-linear processor 110 may be further improved when there is a change in state from a doubletalk condition to a condition that is not doubletalk, or when there is a change in state from a condition that is not near end single talk (NEST) to a near end single talk condition. A near end single talk condition describes a scenario when only the near end local participant is speaking and the near end audio is captured by the microphone. When these particular state changes occur, there may be under-modelling of the tail end of the impulse response of the adaptive filter 106. Such under-modelling may be due to the finite number of taps of the adaptive filter 106, which can result in the tail ends of the output of the adaptive filter 106 being cut off. To address this issue when these particular state changes occur, the transition of the non-linear processor 110 may be slowed by opening the subband slower.

Any process descriptions or blocks in figures should be understood as representing modules, segments, or portions of code which include one or more executable instructions for implementing specific logical functions or steps in the process, and alternate implementations are included within the scope of the embodiments of the invention in which functions may be executed out of order from that shown or discussed, including substantially concurrently or in reverse order, depending on the functionality involved, as would be understood by those having ordinary skill in the art.

The description herein describes, illustrates and exemplifies one or more particular embodiments of the invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the specification is intended to be taken as a whole and interpreted in accordance with the principles of the invention as taught herein and understood to one of ordinary skill in the art.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent, and all equivalents thereof, when interpreted in accordance with the breadth to which they are fairly, legally and equitably entitled.

1. A device, comprising:
one or more processors, any of the one or more processors configured to:
determine whether a conferencing session is in a far end single talk condition, based on a microphone signal and a filtered remote audio signal; and
based on the conferencing session being determined to be in the far end single talk condition, set a threshold of a non-linear processor to be a predetermined amount above a ratio between a level of the microphone signal and a level of the filtered remote audio signal.

2. The device of claim 1, wherein any of the one or more processors is configured to set the threshold of the non-linear processor by setting the threshold of the non-linear processor to be the predetermined amount above a maximum value of the ratio between the level of the microphone signal and the level of the filtered remote audio signal.

3. The device of claim 2, wherein any of the one or more processors is configured to calculate the maximum value of the ratio based on collecting, over a period of time, a plurality of samples of ratios between the level of the microphone signal and the level of the filtered remote audio signal.

4. The device of claim 1, wherein any of the one or more processors is configured to determine whether the conferencing session is in the far end single talk condition based on: a comparison of the filtered remote audio signal to a noise floor, an adaptation state of an adaptive filter, and a coherence of the microphone signal and the filtered remote audio signal.

5. The device of claim 4, wherein any of the one or more processors is configured to determine whether the conferencing session is in the far end single talk condition further based on: an absence of a Geigel doubletalk condition in the microphone signal and the filtered remote audio signal, and a level of wideband doubletalk in the microphone signal and the filtered remote audio signal.

6. The device of claim 1, where any of the one or more processors is further configured to:
determine whether the conferencing session is in a doubletalk condition, based on the microphone signal and the filtered remote audio signal; and
based on the conferencing session being determined to be in the doubletalk condition, set the threshold of the non-linear processor to a predetermined value.

7. The device of claim 6, wherein any of the one or more processors is configured to set the threshold of the non-linear processor by setting the threshold of the non-linear processor to be the predetermined value of no greater than 1 dB.

8. The device of claim 6, wherein any of the one or more processors is configured to determine whether the conferencing session is in the doubletalk condition based on: a Geigel doubletalk condition of the microphone signal and the filtered remote audio signal, and a coherence of the microphone signal and the filtered remote audio signal.

9. The device of claim 8, wherein any of the one or more processors is configured to determine whether the conferencing session is in the doubletalk condition further based on: the Geigel doubletalk condition in one or more subbands of the microphone signal and the filtered remote audio signal, and a level of wideband doubletalk in the microphone signal and the filtered remote audio signal.

10. The device of claim 1, wherein any of the one or more processors is configured to:
adaptively filter a remote audio signal to the filtered remote audio signal;
generate a mask value usable as a gain of the non-linear processor;
multiply the mask value with an initial echo-cancelled audio signal to generate a final echo-cancelled audio signal; and
output the final echo-cancelled audio signal.

11. The device of claim 10, wherein any of the one or more processors is configured to generate the mask value based on an adaptation state of an adaptive filter, a coherence of the microphone signal and the filtered remote audio signal, and a comparison of the microphone signal and the filtered remote audio signal with respect to the threshold of the non-linear processor.

12. A method, comprising:
determining whether a conferencing session is in a far end single talk condition, based on a microphone signal and a filtered remote audio signal; and
based on the conferencing session being determined to be in the far end single talk condition, setting a threshold of a non-linear processor to be a predetermined amount above a ratio between a level of the microphone signal and a level of the filtered remote audio signal.

13. The method of claim 12, wherein setting the threshold of the non-linear processor comprises setting the threshold of the non-linear processor to be the predetermined amount above a maximum value of the ratio between the level of the microphone signal and the level of the filtered remote audio signal.

14. The method of claim 13, further comprising calculating the maximum value of the ratio based on collecting, over a period of time, a plurality of samples of ratios between the level of the microphone signal and the level of the filtered remote audio signal.

15. The method of claim 12, determining whether the conferencing session is in the far end single talk condition comprises determining whether the conferencing session is in the far end single talk condition based on: a comparison of the filtered remote audio signal to a noise floor, an adaptation state of an adaptive filter, and a coherence of the microphone signal and the filtered remote audio signal.

16. The method of claim 12, further comprising:
determining whether the conferencing session is in a doubletalk condition, based on the microphone signal and the filtered remote audio signal; and
based on the conferencing session being determined to be in the doubletalk condition, setting the threshold of the non-linear processor to a predetermined value.

17. The method of claim 16, wherein setting the threshold of the non-linear processor comprises setting the threshold of the non-linear processor to be the predetermined value of no greater than 1 dB.

18. The method of claim 16, wherein determining whether the conferencing session is in the doubletalk condition comprises determining whether the conferencing session is in the doubletalk condition based on: a Geigel doubletalk condition of the microphone signal and the filtered remote audio signal, and a coherence of the microphone signal and the filtered remote audio signal.

19. The method of claim 12, further comprising:
adaptively filtering a remote audio signal to the filtered remote audio signal;
generating a mask value usable as a gain of the non-linear processor;
multiplying the mask value with an initial echo-cancelled audio signal to generate a final echo-cancelled audio signal; and
outputting the final echo-cancelled audio signal.

20. The method of claim 19, wherein generating the mask value comprises generating the mask value based on an adaptation state of an adaptive filter, a coherence of the microphone signal and the filtered remote audio signal, and a comparison of the microphone signal and the filtered remote audio signal with respect to the threshold of the non-linear processor.
